(19) United States
(12) Patent Application Publication
(10) Pub. No.: US 2022/0297980 A1
(43) Pub. Date: Sep. 22, 2022

(54) WALKING DEVICE WITH SELF-ADAPTIVE TRACK GAUGE AND WHEEL PRESSURE FOR PREVENTING RAIL GNAWING

(71) Applicant: Xiamen University, Xiamen (CN)

(72) Inventors: Yu LIU, Xiamen (CN); Wei LAN, Xiamen (CN); Caihuan KE, Xiamen (CN)

(21) Appl. No.: 17/698,372

(22) Filed: Mar. 18, 2022

(30) Foreign Application Priority Data
Mar. 19, 2021 (CN) 202110295845.8

(51) Int. Cl. B66C 9/16; B66C 9/08; B66C 11/06; B66C 7/08

(52) U.S. Cl. CPC B66C 9/16; B66C 9/08; B66C 11/06; B66C 7/08

(57) ABSTRACT

A walking device with a self-adaptive track gauge and wheel pressure for preventing rail gnawing comprises a first rail, a second rail parallel to the first rail, a driving trolley disposed on the first rail, a driven trolley disposed on the second rail, two beams connected between the driving trolley and the driven trolley and each of which having a sliding groove, and an electric hoist disposed on the two beams. The driving trolley is hung on the first rail through a first bearing wheel, and the driven trolley is hung on the second rail through a second bearing wheel. The driving trolley is connected with a driving motor, and the driving trolley is configured to drive the driven trolley to synchronously move along length directions of the first rail and the second rail through the two beams, so that the electric hoist is driven to synchronously move.

### RELATED APPLICATIONS

This application claims priority to Chinese patent application number 202110295845.8, filed on Mar. 19, 2021. Chinese patent application number 202110295845.8 is incorporated herein by reference.

### FIELD OF THE DISCLOSURE

The present disclosure relates to the field of a walking device, and in particular to a walking device with a self-adaptive track gauge and wheel pressure for preventing rail gnawing.

### BACKGROUND OF THE DISCLOSURE

At present, a relative position between rotating axes of a driving wheel and a driven wheel of a trolley running on a double rail or a double beam is fixed, and a relative position between trolley frames respectively disposed with the driving wheel and the driven wheel is fixed, so that there are manufacturing errors, assembly errors, and wear difference, which easily appear on parts such as wheels, gears, etc. If the trolley has two motors to respectively drive two groups of wheels disposed on two sides of the trolley, an electric control circuit is necessarily adopted to maintain a constant rotating speed relationship between the two motors, which increases costs and the problem exists that the two groups of wheels cannot be completely synchronous due to a delay of an electric control response time, a speed difference between the two motors, and the like. If the trolley has a single motor to drive the two groups of the wheels disposed on the two sides of the trolley, a long transmission shaft is configured to drive the two groups of the wheels, and a rotation difference between the two groups of the wheels can be caused by the long transmission shaft with a low rigidity. The manufacturing errors, the assembly errors, the wear difference, the rotation difference, and the like cause the trolley to easily deviate to result in a phenomenon of rail gnawing.

Most existing trolleys adopt a rigid type structure having four fulcrums, and four wheel treads of the four fulcrums are required to be on a same plane. The four wheel treads are not completely on the same plane due to factors, such as manufacturing errors, installation errors, and the like of the trolley and the rail. At a moment when a wheel pressure of one of the four wheels is too small or even zero and wheel pressures of the other three of the four wheels are too large, a phenomenon of three legs occurs. When the trolley runs by three legs, a driving capability is reduced, the trolley easily slips and deviates, and the phenomenon of rail gnawing is caused.

In addition, dimensional accuracy such as a center distance and a straightness of the rail dynamically changes due to the temperature, the running state, and the like, and the rail gauge changes due to expansion and contraction caused by heat and deformation of the rail due to an external load. The phenomena of three legs and rail gnawing can be caused because the two rails are not on a same horizontal plane. When the phenomenon of rail gnawing occurs for a long time, significant damage to relevant equipment such as rail, wheel, and motor can be caused, safe and stable operation can be influenced, and the phenomenon of rail gnawing can lead to a serious incident taking place.

### BRIEF SUMMARY OF THE DISCLOSURE

The present disclosure provides a walking device with a self-adaptive track gauge and wheel pressure for preventing rail gnawing to eliminate a safety hazard of derailment of the walking device and improve reliability and stability of the walking device.

In order to solve the technical problem, a first technical solution of the present disclosure is as follows.

A walking device with a self-adaptive track gauge and wheel pressure for preventing rail gnawing comprises a first rail, a second rail parallel to the first rail, a driving trolley disposed on the first rail, a driven trolley disposed on the second rail, two beams connected between the driving trolley and the driven trolley, each of which has a sliding groove, and an electric hoist disposed on the two beams. The driving trolley is hung on the first rail through a first bearing wheel, and the driven trolley is hung on the second rail through a second bearing wheel. The driving trolley is fixedly connected to hole grooves of the two beams through a first bolt group, and the driven trolley is movably connected to the sliding groove of each of the two beams through a double-headed bolt group. The electric hoist is fixed on a sliding frame through a second bolt group, and the sliding frame is connected with a T-shaped bolt group and is slidingly connected to the sliding groove of each of the two beams through the T-shaped bolt group. The driving trolley is connected with a driving motor, and the driving trolley is configured to drive the driven trolley to synchronously move along length directions of the first rail and the second rail through the two beams so that the electric hoist is driven to synchronously move.

In a preferred embodiment, the driving trolley comprises a first left frame, a first right frame, a third bolt group, a fourth bolt group, the driving motor, a transmission gear box, a first bearing wheel, a first rail side balance wheel group, and a first rail bottom balance wheel group. The first left frame and the first right frame are connected to each other through the third bolt group for limiting a frame distance between the first left frame and the first right frame and the fourth bolt group for connecting the first left frame and the first right frame. The driving motor and the transmission gear box are connected to the first left frame and the first right frame through a sixth bolt group. The first bearing wheel is respectively supported on the first left frame and the first right frame through bearings and shafts. The first rail side balance wheel group is connected to the first left frame and the first right frame through a first support frame and a fifth bolt group, and the first rail bottom balance wheel group is connected to the first left frame and the first right frame through a balance wheel base and a sixth bolt group.

In a preferred embodiment, the driven trolley comprises a second left frame, a second right frame, a seventh bolt group, an eighth bolt group, a second bearing wheel, a second rail side balance wheel group, and a second rail bottom balance wheel group. The second left frame and the second right frame are connected to each other through the seventh bolt group for limiting a frame distance between the second left frame and the second right frame and the eighth bolt group for connecting the second left frame and the second right frame. The second bearing wheel is respectively supported on the second left frame and the second right frame through bearings and shafts, the second rail side balance wheel group is connected to the second left frame and the second right frame through a second support frame and a ninth bolt group, and the second rail bottom balance wheel group is connected to the second left frame and the second right frame through the balance wheel base and a tenth bolt group.

In a preferred embodiment, the first rail side balance wheel group comprises four first rail side balance wheels, and the second rail side balance wheel group comprises four second rail side balance wheels. The first rail bottom balance wheel group comprises two first rail bottom balance wheels, and the second rail bottom balance wheel group comprises two second rail bottom balance wheels.

In a preferred embodiment, a structure of each of the four first rail side balance wheels is the same as a structure of each of the four second rail side balance wheels. Each of the four first rail side balance wheels comprises the first support frame, a first balance wheel base, a first balance wheel limit adjusting bolt, a first balance wheel support, a first balance wheel, a first guide rod bolt group, and a first compression spring. The first balance wheel base is connected to the first support frame through the first guide rod bolt group, and the first guide rod bolt group sequentially passes through the first balance wheel base, the first support frame, the first compression spring, and the first balance wheel support to enable the first compression spring, the first balance wheel support, and the first guide rod bolt group to be connected together. The first compression spring presses the first balance wheel against a side of the first rail through the first balance wheel support, and the first balance wheel limit adjusting bolt defines a retracted location at which the first balance wheel support is configured to be located along a first guide rod through a first nut which is fixedly connected at a middle location of the first balance wheel base, so as to define a maximum offset distance of the driving trolley and the driven trolley along a direction vertical to the side of the first rail and a side of the second rail.

In a preferred embodiment, a structure of each of the two first rail bottom balance wheels is the same as a structure of each of the two second rail bottom balance wheels. Each of the two second rail bottom balance wheels comprises the balance wheel base, a second balance wheel limit adjusting bolt, a second balance wheel support, a second balance wheel, a second compression spring, a second guide rod bolt group, and the tenth bolt group. The balance wheel base is connected to the second left frame and the second right frame through the tenth bolt group, and the second guide rod bolt group is connected to the balance wheel base through a nut fixed on the balance wheel base. The second guide rod bolt group sequentially passes through the balance wheel base, the second left frame, the second right frame, the second compression spring, and the second balance wheel support to enable the second compression spring, the second balance wheel support, and the second guide rod bolt group to be connected together. The second compression spring presses the second balance wheel against a bottom of the second rail through the second balance wheel support, and the second balance wheel limit adjusting bolt defines a retracted location at which the second balance wheel support is configured to be located along a second guide rod through a second nut which is fixedly connected at a middle location of the balance wheel base, so as to define a maximum jumping distance of the driven trolley along a direction vertical to the bottom of the second rail.

In a preferred embodiment, the first bearing wheel comprises a first left bearing wheel and a first right bearing wheel, and the second bearing wheel comprises a second left bearing wheel and a second right bearing wheel. The first left bearing wheel, the second left bearing wheel, and the second right bearing wheel are driven wheels. The first right bearing wheel is connected to the driving motor, the first right bearing wheel is a driving wheel, and the driving motor is configured to transmit power to the driving wheel so as to drive the driven wheels to move along the first rail and the second rail.

In a preferred embodiment, a track gauge between the first rail and the second rail is represented by Lᵣₐᵢₗ, and an axle distance between the first left bearing wheel and the first right bearing wheel is represented by Lₐₓₗₑ. An axle distance between two of the four first rail side balance wheels that are located on a same side of the first rail is represented by L_{wheel}, and a distance between a driving force F_{driving} of the driving wheel and a friction force F₅ on a first of the driven wheels is represented by L_{driving}. A distance between friction forces F₆, F₇ on a second and third of the driven wheels is represented by L_{driven}, and an acting force of the first rail acting on the driving wheel is the driving force F_{driving} whose direction is the same as a moving direction of the walking device. Rolling frictions applied by the second rail to the driven wheels are resistance forces represented by F₁, F₂, F₃, F₄, F₅, F₆, and F₇, and the driving force F_{driving} applied on the driving wheel and the rolling frictions F₁, F₂, F₃, F₄, F₅, F₆, F₇ applied on the driven wheels are configured to generate a deflection torque around a center O of the walking device so that a respective two of the four first rail side balance wheels that are arranged on two sides of the first rail and a respective two of the four second rail side balance wheels that are arranged on two sides of the second rail are respectively pressed onto the two sides of the first rail and the two sides of the second rail to generate four rail side pressures F_{N1}, F_{N2}, F_{N3}, and F_{N4}. The four rail side pressures F_{N1}, F_{N2}, F_{N3}, and F_{N4} are configured to generate a torque that balances the deflection torque. An equilibrium equation between force and moment is shown as follow:

F_{driving}=F₁+F₂+F₃+F₄+F₅+F₆+F₇ (1),

F_{N1}+F_{N3}=F_{N2}+F_{N4} (2),

(F_{driving}+F₅)×L_{driving}+(F₆−F₇)×L_{driven}+(F₃+F₄−F₁−F₂)×Lᵣₐᵢₗ=L_{wheel}×(F_{N1}+F_{N2}+F_{N3}+F_{N4}) (3).

A rail width of the first rail and the second rail is negligible relative to the track gauge Lᵣₐᵢₗ, so that L_{driving}=L_{driven}=Lᵣₐᵢₗ, and the formulas (1) and (2) are substituted into the formula (3) to obtain the formula (4):

(F₃+F₄+F₅+F₆)×Lᵣₐᵢₗ=(F_{N1}+F_{N3})×L_{wheel} (4).

Rolling friction coefficients of the driving wheel and the driven wheels are considered as fᵣₒₗₗ, so that F_{N1}=F_{N2}=F_{N3}=F_{N4}=F_{N}, F₃+F₄=(F_{N3}+F_{N4})×fᵣₒₗₗ=2×F_{N}×fᵣₒₗₗ, and F₅+F₆=F_{weight}×fᵣₒₗₗ, wherein the F_{weight} is a total weight borne by the second bearing wheel of the driven trolley, and the above formulas are substituted into formula (4) to obtain the formulas (5) and (6):

$$\begin{matrix}FN = \frac{Fweight \times froll \times Lrail}{2 \times Lwheel - 2 \times froll \times Lrail} , & ( 5 ) \\ Lwheel = [ \frac{Fweight}{2 \times FN} + 1 ] \times froll \times Lrail . & ( 6 )\end{matrix}$$

The formula (5) illustrates a relationship among the F_{N}, the fᵣₒₗₗ, the L_{wheel}, the Lᵣₐᵢₗ, and the F_{weight}, and under a condition that other parameters are fixed, the fᵣₒₗₗ is positively correlated with the F_{N}; the L_{wheel} is negatively correlated with the F_{N}; the Lᵣₐᵢₗ is positively correlated with the F_{N}; the F_{weight} is positively correlated with the F_{N}. The formula (6) illustrates a method for setting the axle distance relative to the track gauge. The method comprises: (1) determining a limit value F_{side limit} of the rail side pressure F_{N} according to an ultimate stress of a rail material, (2) substituting the F_{side} limit into the formula (6) to obtain a lowest limit value of the L_{wheel}, and (3) selecting a value of the L_{wheel} according to the lowest limit value of the L_{wheel}.

In a preferred embodiment, the hole grooves of each of the two beams is divided into a first hole groove and a second hole groove, and the driving trolley is fixedly connected with the first hole groove and the second hole groove through the first bolt group. A length of an unthreaded part of a double-headed bolt of the double-headed bolt group is greater than a sum of a thicknesses of a corresponding one of the second left frame and the second right frame and each of the two beams at a junction of the corresponding one of the second left frame and the second right frame and each of the two beams. When a distance between the first rail and the second rail is changed, the driven trolley and the double-headed bolt group slide along the sliding groove so as to adapt different track gauges. A gravity center of the driving trolley is marked as O, F_{G} is a gravity of the driving trolley, F_{bearing 1} and F_{bearing 2} are positive pressures which are respectively applied to the first left bearing wheel and the first right bearing wheel by the first rail, F_{N5} and F_{N6} are positive pressures which are respectively applied by the first rail to the two first rail bottom balance wheels, which are separated from each other in a front-rear direction, F_{beam 1} and F_{beam 2} are downward pulling forces which are applied by the two beams to the first left frame and the first right frame of the driving trolley, and an equilibrium equation for force and moment is shown as follow:

F_{bearing 1}+F_{bearing 2}=F_{G}+F_{N5}+F_{N6}+F_{beam 1}+F_{beam 2} (7),

(F_{bearing 1}−F_{bearing 2})×Lₐₓₗₑ=(F_{N5}−F_{N6})×L_{wheel}+(F_{beam 1}−F_{beam 2})×L_{beam} (8).

L_{beam} is a distance between the two beams, and when F_{beam 1}=F_{beam 2}, F_{bearing 1}=F_{bearing 2} and the first left bearing wheel and the first right bearing wheel are stressed evenly, the positive pressures F_{N5} and F_{N6} which are applied by the first rail to the two first rail bottom balance wheels are ignored. When a stress on the two beams is unbalanced and the F_{beam 1} is larger than the F_{beam 2}, the driving trolley is subjected to a counterclockwise turning moment around the gravity center O. Let F_{beam 2}=0 and F_{N5}=0, then:

(F_{bearing 1}−F_{bearing 2})×Lₐₓₗₑ=F_{beam 1}×L_{beam}−F_{N6}×L_{wheel} (9),

from the above formula, when

$${F}_{beam 1} \times {L}_{beam} - {F}_{N 6} \times {L}_{wheel} = 0 , {F}_{N 6} = \frac{{F}_{beam 1} \times {L}_{beam}}{{L}_{wheel}} , {F}_{bearing 1} - {F}_{bearing 2} = 0$$

and the first left bearing wheel and the first right bearing wheel are still stressed in balance, and the formula (9) shows that when the stress on the two beams is unbalanced, the two first rail bottom balance wheels are configured to reduce an unbalanced degree of the stress on the first left bearing wheel and the first right bearing wheel.

In a preferred embodiment, when a direction of a trolley body and a direction of the rail deviate from each other and the four first rail side balance wheels and the four second rail side balance wheels reach a maximum retraction distance b due to a limitation of a limit adjusting bolt: a deflection angle is a maximum deflection angle α, a diameter of each of the four first rail side balance wheels is set as d₁, diameters of a first bearing wheel and a second bearing wheel are set as d₂, a width of the rail is set as w, a wall thickness of the rail is set as s, then

$$2 \times b + {d}_{1} + s - \frac{{d}_{1} + s}{cos α} = {L}_{wheel} \times tan α . \qquad ( 10 )$$

The larger the maximum retraction distance b, the larger the maximum deflection angle α; when b is determined, the maximum deflection angle α is determined. A condition that the rail gnawing does not occur is that projection straight lines EF, GH of a rail edge of the rail projected on a rail plane do not intersect with sides AB, DC of a circumscribed rectangle ABCD projected by the first left bearing wheel and the first right bearing wheel on the rail plane, then:

$$BC \geq ( {L}_{axle} + {d}_{2} ) \times tan α + \frac{w}{cos α} . \qquad ( 11 )$$

BC=w+c is set, wherein c is a minimum gap value which should be reserved between an edge of each of the first left bearing wheel and the first right bearing wheel and the rail edge of the rail after the driving trolley is installed on the rails, then:

$$c \geq ( {L}_{axle} + {d}_{2} ) \times tan α - w + \frac{w}{cos α} . \qquad ( 12 )$$

The minimum gap value c between the edge of each of the first left bearing wheel and the first right bearing wheel and the rail edge of the rail is adjusted through a frame spacing limiting bolt group and a frame connecting bolt group, and the maximum retraction distance b is adjusted through a balance wheel limit adjusting bolt. According to the formulas (10) and (12), when the minimum gap value c is given, the maximum deflection angle α of the rail and the maximum retraction distance b of rail side balance wheels which are set to prevent rail gnawing is configured to be calculated. When the maximum retraction distance b of rail side balance wheels is given, the maximum deflection angle α of the rail and the minimum gap value c at which no rail gnawing occurs is configured to be calculated.

The frame distance between the first left frame and the first right frame and the frame distance between the second left frame and the second right frame are configured to be adjusted to adjust the minimum gap value c.

A method of adjusting the frame distance between the first left frame and the first right frame is the same as a method of adjusting the frame distance between the second left frame and the second right frame, and the method of adjusting the frame distance between the first left frame and the first right frame comprises: tightening the fourth bolt group to decrease the frame distance between the first left frame and the first right frame, or to loosening the fourth bolt group to increase the frame distance between the first left frame and the first right frame.

When the frame distance between the first left frame and the first right frame reaches a set value, the third bolt group is tightened to maintain the frame distance at the set value.

In order to adjust the four first rail side balance wheels and the two beams to adapt to the frame distance between the frames, through grooves are arranged on the first left frame, the first right frame, and the two beams, and the frame distance between the first left frame and the first right frame is configured to be adjusted to enable the driving trolley and the driven trolley to be suitable for rails of different types or widths.

Compared with the existing techniques, the technical solution has the following advantages.

(1) The present disclosure can automatically adapt to a deviation of the track gauge, and has a certain adaptability of a track height difference. The driven trolley is movably connected with the two beams, has a large moving range in a direction of the track gauge and a certain moving range in a direction vertical to a side of the rail, so that the driven trolley can automatically adapt to the deviation of the track gauge and has the certain adaptability of the track height difference.

(2) The present disclosure can adapt to a bearing wheel pressure change caused by an unbalanced stress of the two beams and avoid a phenomenon of three legs. The rail bottom balance wheels can balance the unbalanced stress of the two beams, reduce an unbalanced stress degree of the bearing wheels, and automatically balance the wheel pressure of the bearing wheels. Meanwhile, the rail bottom balance wheels can compensate for a reduction of the wheel pressure of the bearing wheels, and the phenomenon of three legs is avoided.

(3) The present disclosure adopts a structure of a single-side drive, has a simple structure and a lower cost, can keep the driving trolley and the driven trolley running synchronously, and prevent deviation and rail gnawing. The present disclosure also provides a relationship between the rail side pressures, the track gauge, the axle distance of the balance wheels, the rolling friction coefficient, and the total weight borne by the second bearing wheel and provides a method for setting the track gauge relative to the axle distance of the rail side balance wheels.

(4) The present disclosure forms a rail holding system by the bearing wheel, the rail side balance wheel, and the rail bottom balance wheel that can effectively prevent rail gnawing and the derailing phenomena and provides a method for setting the maximum retracted distance of the rail side balance wheel and the minimum gap value between the bearing wheel and the edge of the rail, which prevents rail gnawing.

(5) The present disclosure can adjust a space between two side plates of the trolley and is suitable for tracks of different types or widths. The two side plates of the trolley can be adjusted without the two side plates of the trolley removed through a frame connecting bolt group and a frame distance limiting bolt group. However, two side plates of the existing trolleys are generally adjusted through adding or removing gaskets or sleeves to achieve adjusting the frame distance, and the two side plates of the existing trolleys must be removed when the frame distance needs to be adjusted, which is cumbersome and laborious and has a low adjustment accuracy due to a fixed thickness of the gaskets and a fixed width of the sleeves.

(6) The electric hoist can move transversely on the sliding groove and can also move longitudinally under a driving of the trolleys (i.e., the driving trolley and the driven trolley), so that the electric hoist has a larger working range.

(7) The present disclosure adopts a single-side driving, and wheels of the driving trolley and the driven trolley are not directly connected together, thus being capable of adapting to a condition of larger track gauge. Wheels of the existing trolleys that are traditional double-beam rail trolleys are connected to each other through a transmission device such as a long-distance shaft, which limit a distance between the double-beam.

### BRIEF DESCRIPTION OF THE DRAWINGS

FIG. 1 illustrates a perspective view of a walking device with a self-adaptive track gauge and wheel pressure for preventing rail gnawing in a preferred embodiment in the present disclosure.

FIG. 2 illustrates a front-rear side view of the walking device, illustrating a connecting relationship among a driving trolley, a driven trolley, two beams, and an electric hoist in a preferred embodiment in the present disclosure.

FIG. 3 illustrates a perspective view of the driving trolley of the walking device in a preferred embodiment in the present disclosure.

FIG. 4 illustrates a perspective view of the driven trolley of the walking device in a preferred embodiment in the present disclosure.

FIG. 5 illustrates a perspective view of one of four first rail side balance wheels of the walking device in a preferred embodiment in the present disclosure.

FIG. 6 illustrates a front-rear side view and a bottom view of one of two first rail bottom balance wheels of the walking device in a preferred embodiment in the present disclosure.

FIG. 7 illustrates a top view of the driving trolley of the walking device in a preferred embodiment in the present disclosure.

FIG. 8 illustrates a top view of the two beams of the walking device in a preferred embodiment in the present disclosure.

FIG. 9 illustrates a top view of the walking device in which a force analysis diagram is illustrated in a preferred embodiment in the present disclosure.

FIG. 10 illustrates a left-right side view of the walking device in which a force analysis diagram is illustrated in a preferred embodiment in the present disclosure.

FIG. 11 illustrates a schematic diagram of rail gnawing prevention of the walking device in a preferred embodiment in the present disclosure.

### DETAILED DESCRIPTION OF THE EMBODIMENTS

The present disclosure will be further described below in combination with the accompanying drawings and embodiments.

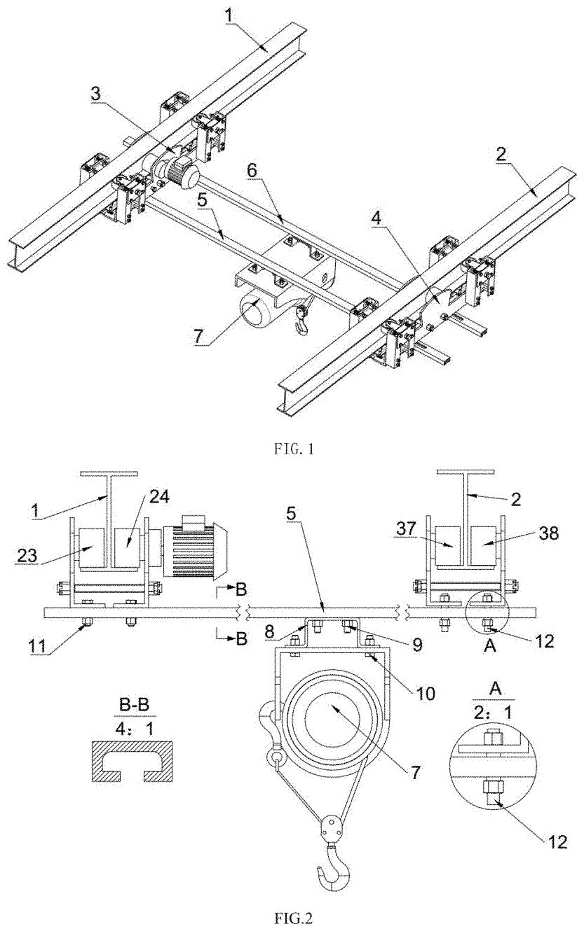

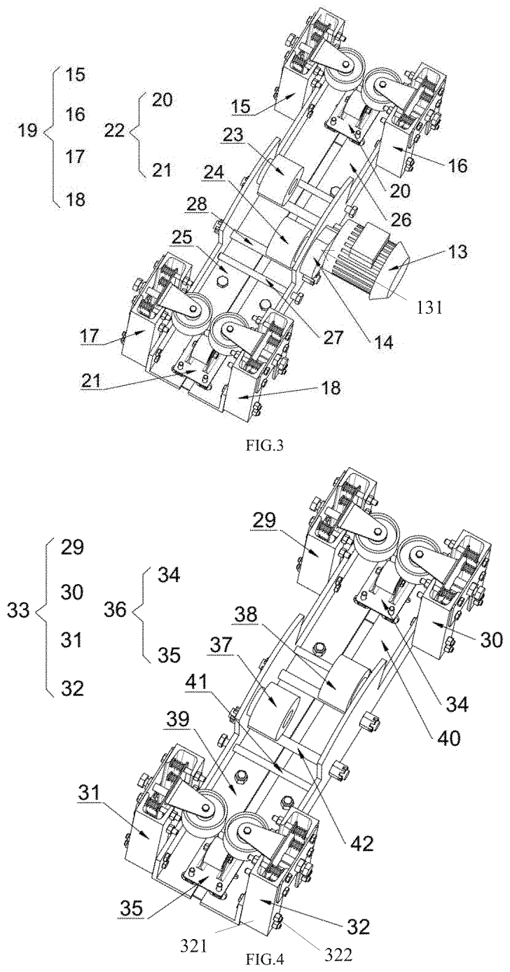

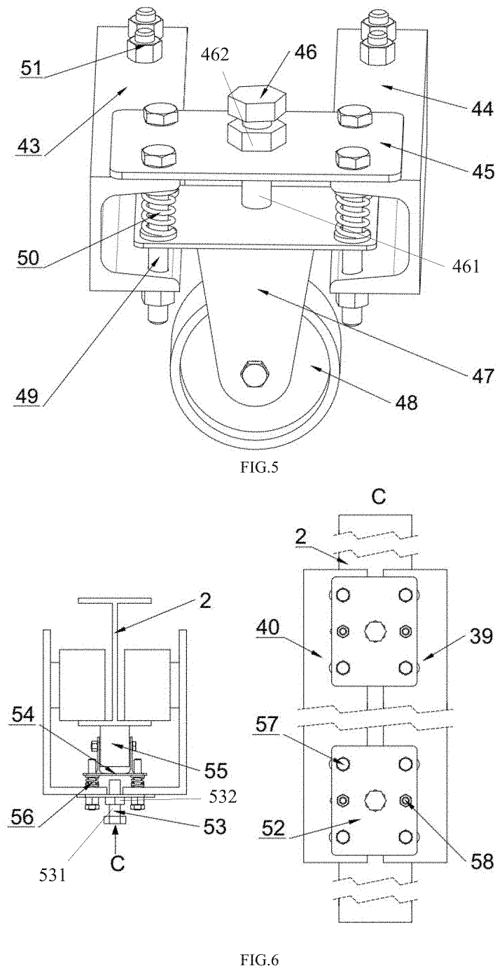

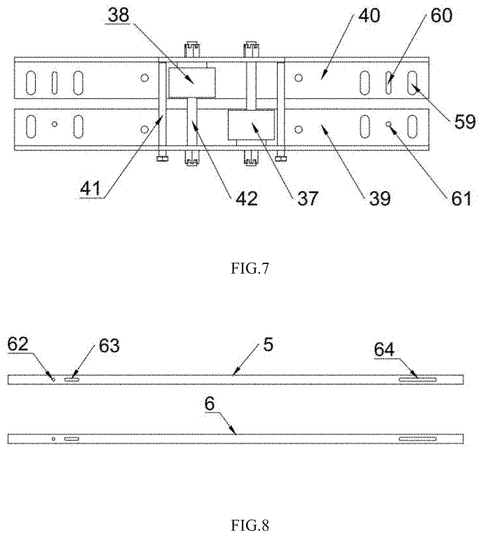

Referring to FIGS. 1-11, a walking device with a self-adaptive track gauge and wheel pressure for preventing rail gnawing comprises a first rail 1, a second rail 2 parallel to the first rail 1, a driving trolley 3 disposed on the first rail 1, and a driven trolley 4 disposed on the second rail 2. Two beams are connected between the driving trolley 3 and the driven trolley 4. Each of the two beams has a sliding groove 64, and the two beams are divided into a first beam 5 and a second beam 6. An electric hoist 7 is disposed on the first beam 5 and the second beam 6.

The driving trolley 3 is hung on the first rail 1 through a first bearing wheel, and the driven trolley 4 is hung on the second rail 2 through a second bearing wheel. The driving trolley 3 is fixedly connected to hole grooves of the two beams through a first bolt group 11, and the driven trolley 4 is movably connected to the sliding groove 64 of each of the two beams through a double-headed bolt group 12. The electric hoist 7 is fixed on a sliding frame 8 through a second bolt group 10. The sliding frame 8 is connected with a T-shaped bolt group 9, and the sliding frame 8 is slidingly connected to the sliding groove 64 of each of the two beams through the T-shaped bolt group 9. The driving trolley 3 is connected with a driving motor 13, and the driving trolley 3 drives the driven trolley 4 to synchronously move along length directions of the first rail 1 and the second rail 2 through the two beams, so that the electric hoist 7 is driven to synchronously move.

Specifically, the first bearing wheel comprises a first left bearing wheel 23 and a first right bearing wheel 24, and the second bearing wheel comprises a second left bearing wheel 37 and a second right bearing wheel 38. The first left bearing wheel 23, the second left bearing wheel 37, and the second right bearing wheel 38 are driven wheels. The first right bearing wheel 24 is connected to the driving motor 13, and the first right bearing wheel 24 is a driving wheel. The driving motor 13 transmits power to the driving wheel, thereby driving the driven wheels to move along the first rail 1 and the second rail 2.

The driving trolley 3 comprises a first left frame 25, a first right frame 26, a third bolt group 27, a fourth bolt group 28, the driving motor 13, a transmission gear box 14, the first bearing wheel, a first rail side balance wheel group 19, and a first rail bottom balance wheel group 22. The first left frame 25 and the first right frame 26 are connected to each other through the third bolt group 27 for limiting a frame distance between the first left frame 25 and the first right frame 26 and the fourth bolt group 28 for connecting the first left frame 25 and the first right frame 26. The driving motor 13 and the transmission gear box 14 are also connected to the first left frame 25 and the first right frame 26 through a sixth bolt group 131. The first left bearing wheel 23 and the first right bearing wheel 24 are respectively supported on the first left frame 25 and the first right frame 26 through bearings and shafts. The first rail side balance wheel group 19 is connected to the first left frame 25 and the first right frame 26 through a first support frame and a fifth bolt group 51. The first rail bottom balance wheel group 22 is connected to the first left frame 25 and the first right frame 26 through a balance wheel base 52 and a tenth bolt group 58. Specifically, the first rail bottom balance wheel group 22 comprises two first rail bottom balance wheels 20, 21.

The driven trolley 4 comprises a second left frame 39, a second right frame 40, a seventh bolt group 41, an eighth bolt group 42, the second bearing wheel, a second rail side balance wheel group 33, and a second rail bottom balance wheel group 36. The second left frame 39 and the second right frame 40 are connected by the seventh bolt group 41 for limiting a frame distance between the second left frame 39 and the second right frame 40 and the eighth bolt group 42 for connecting the second left frame 39 and the second right frame 40. The second left bearing wheel 37 and the second right bearing wheel 38 are respectively supported on the second left frame 39 and the second right frame 40 through bearings and shafts. The second rail side balance wheel group 33 is connected to the second left frame 39 and the second right frame 40 through a second support frame 321 and a ninth bolt group 322. The second rail bottom balance wheel group 36 is connected to the second left frame 39 and the second right frame 40 through the balance wheel base 52 and the tenth bolt group 58. Specifically, the second rail bottom balance wheel group 36 comprises two second rail bottom balance wheels 34, 35.

The first rail side balance wheel group 19 comprises four first rail side balance wheels 15, 16, 17, 18. The second rail side balance wheel group 33 comprises four second rail side balance wheels 29, 30, 31, 32. The first rail bottom balance wheel group 22 comprises the two first rail bottom balance wheels 20, 21. The second rail bottom balance wheel group 36 comprises the two second rail bottom balance wheels 34, 35.

A structure of each of the four first rail side balance wheels 15, 16, 17, 18 is the same as a structure of each of the four second rail side balance wheels 29, 30, 31, 32. Each of the four first rail side balance wheels 15, 16, 17, 18 comprises the first support frame, a first balance wheel base 45, a first balance wheel limit adjusting bolt 46, a first balance wheel support 47, a first balance wheel 48, a first guide rod bolt group 49, and a first compression spring 50. The first support frame is divided into two support frame 43, 44. The first balance wheel base 45 is connected to the first support frame through the first guide rod bolt group 49. The first guide rod bolt group 49 sequentially passes through the first balance wheel base 45, the first support frame, the first compression spring 50, and the first balance wheel support 47 to enable the first compression spring 50, the first balance wheel support 47, and the first guide rod bolt group 49 to be connected together. The first compression spring 50 presses the first balance wheel 48 tightly against a side of the first rail 1 through the first balance wheel support 47. The first balance wheel limit adjusting bolt 46 defines a retracted location at which the first balance wheel support 47 is configured to be located along a first guide rod 461 through a first nut 462 which is fixedly connected at a middle location of the first balance wheel base 45, so as to define a maximum offset distance of the driving trolley 3 and the driven trolley 4 along a direction vertical to the side of the first rail 1 and a side of the second rail 2.

A structure of each of the two first rail bottom balance wheels 20, 21 is the same as a structure of each of the two second rail bottom balance wheels 34, 35. Each of the two second rail bottom balance wheels 34, 35 comprises the balance wheel base 52, a second balance wheel limit adjusting bolt 53, a second balance wheel support 54, a second balance wheel 55, a second compression spring 56, a second guide rod bolt group 57, and the tenth bolt group 58. The balance wheel base 52 is connected to the second left frame 39 and the second right frame 40 through the tenth bolt group 58. The second guide rod bolt group 57 is connected to the balance wheel base 52 through a nut fixed on the balance wheel base 52. The second guide rod bolt group 57 sequentially passes through the balance wheel base 52, the second left frame 39, the second right frame 40, the second compression spring 56, and the second balance wheel support 54 to enable the second compression spring 56, the second balance wheel support 54, and the second guide rod bolt group 57 to be connected together. The second compression spring 56 presses the second balance wheel 55 tightly against a bottom of the second rail 2 through the second balance wheel support 54. The second balance wheel limit adjusting bolt 53 defines a retracted location at which the second balance wheel support 54 is configured to be located along a second guide rod 531 through a second nut 532 which is fixedly connected at a middle location of the balance wheel base 52, so as to define a maximum jumping distance of the driven trolley 4 along a direction vertical to the bottom of the second rail 2.

A track gauge between the first rail 1 and the second rail 2 is represented by Lᵣₐᵢₗ, an axle distance between the first left bearing wheel 23 and the first right bearing wheel 24 is represented by Lₐₓₗₑ, an axle distance between two of the four first rail side balance wheels 15, 16, 17, 18 that are located on the same side of the first rail 1 is represented by L_{wheel}, a distance between a driving force F_{driving} of the driving wheel and a friction force F₅ on one of the driven wheels that is symmetrically arranged with respect to the driving wheel on two sides of the Z axis is represented by L_{driving}, and a distance between friction forces F₆, F₇ on the other two of driven wheels is represented by L_{driven}. An acting force of the first rail 1 acting on the driving wheel is the driving force F_{driving} whose direction is the same as a moving direction of the walking device. Rolling frictions applied by the second rail 2 to the driven wheels are resistance forces represented by F₁, F₂, F₃, F₄, F₅, F₆, and F₇ (the forces of the driven wheels acting on the first rail bottom balance wheels 20, 21 and the second rail bottom balance wheels 34, 35 are not taken into account). The driving force F_{driving} applied on the driving wheel and the rolling frictions F₁, F₂, F₃, F₄, F₅, F₆, F₇ applied on the driven wheels generate a deflection torque around a center O of the walking device, so that a respective two of the four first rail side balance wheels 15, 16, 17, 18 that are arranged on two sides of the first rail 1, and a respective two of the four second rail side balance wheels 29, 30, 31, 32 that are arranged on two sides of the second rail 2 are respectively pressed onto the two sides of the first rail 1 and the two sides of the second rail 2 to generate four rail side pressures F_{N1}, F_{N2}, F_{N3}, and F_{N4}. The four rail side pressures F_{N1}, F_{N2}, F_{N3}, and F_{N4} will create a torque that balances the deflection torque, and an equilibrium equation between force and moment is shown as follow.

F_{driving}=F₁+F₂+F₃+F₄+F₅+F₆+F₇ (1);

F_{N1}+F_{N3}=F_{N2}+F_{N4} (2);

(F_{driving}+F₅)×L_{driving}+(F₆−F₇)×L_{driven}+(F₃+F₄−F₁−F₂)×Lᵣₐᵢₗ=L_{wheel}×(F_{N1}+F_{N2}+F_{N3}+F_{N4}) (3).

A rail width of the first rail 1 and the second rail 2 is negligible relative to a track gauge, so that L_{driving} is equal to L_{driven}, is equal to Lᵣₐᵢₗ; the formulas (1) and (2) are substituted into the formula (3) to obtain the formula (4).

(F₃+F₄+F₅+F₆)×Lᵣₐᵢₗ=(F_{N1}+F_{N3})×L_{wheel} (4).

Rolling friction coefficients of the driving wheel and the driven wheels are considered as fᵣₒₗₗ, so that F_{N1}=F_{N2}=F_{N3}=F_{N4}=F_{N}, F₃+F₄=(F_{N3}+F_{N4})×fᵣₒₗₗ=2×F_{N}×fᵣₒₗₗ, and F₅+F₆=F_{weight}×Lᵣₒₗₗ, wherein the F_{weight} is a total weight borne by the second bearing wheel of the driven trolley. The above formulas are substituted into formula (4) to obtain the formulas (5) and (6).

$$\begin{matrix}FN = \frac{Fweight \times froll \times Lrail}{2 \times Lwheel - 2 \times froll \times Lrail} ; & ( 5 ) \\ Lwheel = [ \frac{Fweight}{2 \times FN} + 1 ] \times froll \times Lrail ; & ( 6 )\end{matrix}$$

The formula (5) illustrates a relationship among the F_{N}, the fᵣₒₗₗ, the L_{wheel}, the Lᵣₐᵢₗ, and the F_{weight}. Under a condition that other parameters are fixed, the fᵣₒₗₗ is positively correlated with the F_{N}; the L_{wheel} is negatively correlated with the F_{N}; the Lᵣₐᵢₗ is positively correlated with the F_{N}; the F_{weight} is positively correlated with the F_{N}. The formula (6) illustrates a method for setting the axle distance relative to the track gauge: the method comprises: (1) determining a limit value F_{side limit} of the rail side pressure F_{N} according to an ultimate stress of a rail material; (2) substituting the F_{side limit} into the formula (6) to obtain a lowest limit value of the L_{wheel}, and (3) selecting a proper value of the L_{wheel} according to the lowest limit value of the L_{wheel}.

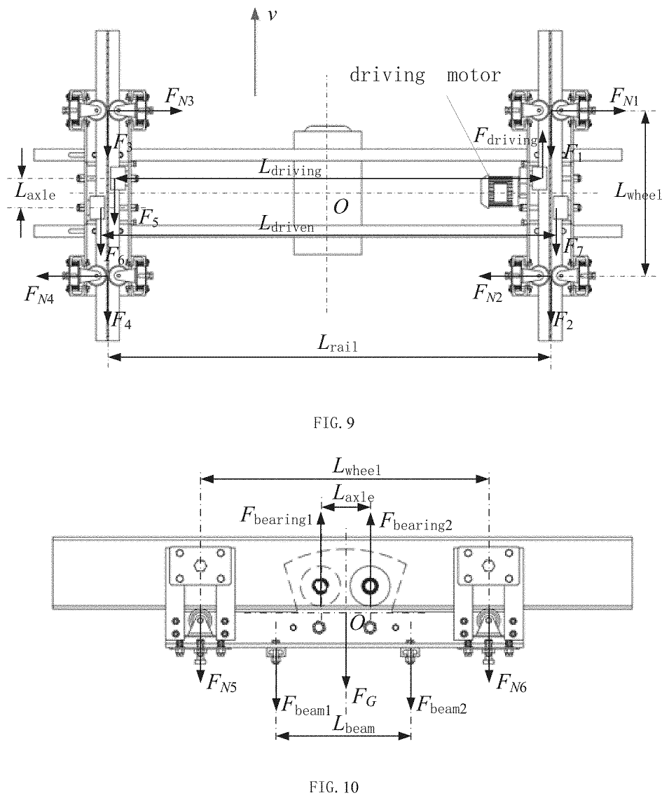

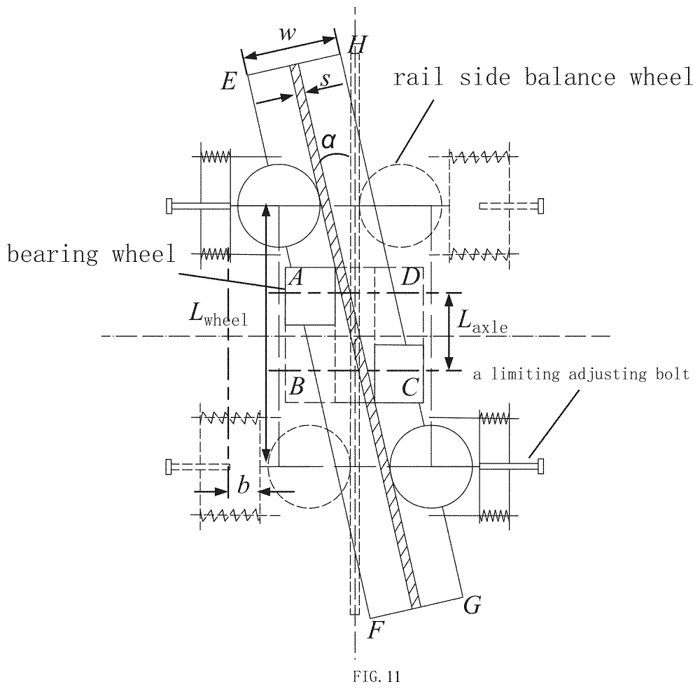

The hole grooves of each of the two beams is divided into a first hole groove 62 and a second hole groove 63. Frames (i.e., the first left frame 25, the first right frame 26, the second left frame 39, and the second right frame 40) of the walking device comprise through grooves 59 for being connected with the first compression spring 50 and the second compression spring 56. The frames of the walking device comprise fixing grooves 60 and holes 61 for being connected with the balance wheel base 52. The driving trolley 3 is fixedly connected with the first hole groove 62 and the second hole groove 63 through the first bolt group 11. A length of an unthreaded part of a double-headed bolt of the double-headed bolt group 12 is greater than a sum of a thickness of the frame (i.e., the first left frame 25 or first right frame 26) and each of the two beams at a junction of the frame and each of the two beams. When a distance between the first rail 1 and the second rail 2 is changed, the driven trolley 4 and the double-headed bolt group 12 slide along the sliding groove 64, so as to adapt to different track gauges. Referring to FIG. 10, a gravity center of the driving trolley 3 is marked as O, F_{G} is a gravity of the driving trolley 3, F_{bearing 1} and F_{bearing 2} are positive pressures which are respectively applied to the first left bearing wheel 23 and the first right bearing wheel 24 by the first rail 1, F_{N5} and F_{N6} are positive pressures which are respectively applied by the first rail 1 to the two first rail bottom balance wheels 20, 21 which are separated from each other in a front-rear direction, and F_{beam 1} and F_{beam 2} are downward pulling forces which are applied by the two beams to the frames of the driving trolley 3. The equilibrium equation for force and moment is shown as follow.

F_{bearing 1}+F_{bearing 2}=F_{G}+F_{N5}+F_{N6}+F_{beam 1}+F_{beam 2} (7);

(F_{bearing 1}−F_{bearing 2})×Lₐₓₗₑ=(F_{N5}−F_{N6})×L_{wheel}+(F_{beam 1}−F_{beam 2})L_{beam} (8);

When the F_{beam 1} is equal to the F_{beam 2}, the F_{bearing 1} is equal to the F_{bearing 2}, the bearing wheels (i.e., the first bearing wheel and the second bearing wheel) are stressed evenly, and the positive pressures F_{N5} and F_{N6} which are applied by the rail to the rail bottom balance wheels are ignored. When a stress on the two beams is unbalanced and the F_{beam 1} is far larger than the F_{beam 2}, the driving trolley 3 is subjected to a counterclockwise turning moment around the gravity center O. When F_{beam 2}=0 and F_{N5}=0, then:

(F_{bearing 1}−F_{bearing 2})×Lₐₓₗₑ=F_{beam 1}×L_{beam}−F_{N6}×L_{wheel} (9);

From the above formula, when

$${F}_{beam 1} \times {L}_{beam} - {F}_{N 6} \times {L}_{wheel} = 0 , {F}_{N 6} = \frac{{F}_{beam 1} \times {L}_{beam}}{{L}_{wheel}} , {F}_{bearing 1} - {F}_{bearing 2} = 0 ,$$

that is, the bearing wheels are still stressed in balance. The formula (9) shows that when the stress on the two beams is unbalanced, the rail bottom balance wheels 20, 21, 34, 35 help to reduce an unbalanced degree of the stress on the bearing wheels.

The present disclosure forms a rail holding system by the bearing wheels, the rail side balance wheels, and the rail bottom balance wheels vertical to the rail side balance wheels, thereby effectively avoiding an occurrence of gnawing rail and derailing. The rail bottom balance wheels can prevent the trolleys (i.e., the driving trolley 3 and the driven trolley 4) from overturning forwards and backwards. The rail side balance wheels define a maximum deflection angle between a trolley body (i.e., a trolley body of the driving trolley 3 or the driven trolley 4) and the rail (i.e., the first rail 1 and the second rail 2), and prevent the rail from being gnawed. In order to prevent gnawing rail, after the trolleys are installed on the rail, a minimum gap value between an edge of the bearing wheels (i.e., the first bearing wheel or the second bearing wheel) and an edge of the rail, a maximum retracted distance (i.e., the maximum retracted position) of the rail side balance wheels on the side of the rail and a deflection angle between the trolley and the rail need to meet a certain constraint relation. The following provides a method for setting the maximum retracted distance of the rail side balance wheels and the minimum gap value for preventing the rail from being gnawed. Referring to FIG. 11, a direction of the trolley body and a direction of the rail deviate from each other. When the rail side balance wheels reach the maximum retraction distance b due to a limitation of a limit adjusting bolt (i.e., the first balance wheel limit adjusting bolt 46 or the second balance wheel limit adjusting bolt 53), the deflection angle is a maximum deflection angle α. A diameter of each of the rail side balance wheels is set as d₁, diameters of the first bearing wheel and the second bearing wheel are set as d₂, the axle distance between two of the rail side balance wheels that are located on the same side of the rail is set as the L_{wheel}, the axle distance between the bearing wheels is set as the Lₐₓₗₑ, a width of the rail is set as w, and a wall thickness of the rail is set as s; then

$$2 \times b + {d}_{1} + s - \frac{{d}_{1} + s}{cos α} = {L}_{wheel} \times tan α ; \qquad ( 10 )$$

As can be seen from formula (10), the larger the maximum retraction distance b, the larger the maximum deflection angle α. When b is determined, the maximum deflection angle α is also determined. The gnawing rail does not occur when projection straight lines EF, GH of rail edge of the rail projected on a rail plane do not intersect with sides AB, DC of a circumscribed rectangle ABCD projected by the bearing wheels on the rail plane, then:

$$BC \geq ( {L}_{axle} + {d}_{2} ) \times tan α + \frac{w}{cos α} . \qquad ( 11 )$$

BC=w+c is set, wherein c is the minimum gap value which should be reserved between the edge of the bearing wheels and the edge of the rail after the trolleys are installed on the rails; then:

$$c \geq ( {L}_{axle} + {d}_{2} ) \times tan α - w + \frac{w}{cos α} . \qquad ( 12 )$$

The minimum gap value c between the edge of the bearing wheels and the edge of the rail is adjusted through a frame spacing limiting bolt group and a frame connecting bolt group (i.e., the third bolt group 27, the fourth bolt group 28, the seventh bolt group 41, and the eighth bolt group 42), and the maximum retraction distance b is adjusted through a balance wheel limit adjusting bolt (i.e., the first balance wheel limit adjusting bolt 46 or the second balance wheel limit adjusting bolt 53). According to the formulas (10) and (12), when the gap value c is given, the maximum deflection angle α of the rail and the maximum retraction distance b of rail side balance wheels which are set to prevent rail gnawing can be calculated. When the maximum retraction distance b of rail side balance wheels is given, the maximum deflection angle α of the rail and the minimum gap value c at which no track gnawing occurs can be calculated.

The present disclosure can adjust the frame distance between the first left frame 25 and the first right frame 26, and is suitable for rails of different types or widths. The frame distance between the first left frame 25 and the first right frame 26 is adjusted in the same method as the frame distance between the second left frame 39 and the second right frame 40. The adjustment method is to tighten the fourth bolt group 28 to decrease the frame distance between the first left frame 25 and the first right frame 26, or to loosen the fourth bolt group 28 to increase the frame distance between the first left frame 25 and the first right frame 26. When the frame distance between the first left frame 25 and the first right frame 26 reaches a set value, the third bolt group 27 is tightened to maintain the frame distance at the set value. In order to adjust the rail bottom balance wheels and the two beams to adapt to the space between the frames, the through grooves are arranged on the first left frame 25, the first right frame 26, and the two beams.

In addition, this embodiment is a double rail embodiment. When the two beams have been removed, the electric hoist can be installed below the driving trolley 3 to achieve a monorail motion.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A walking device with a self-adaptive track gauge and wheel pressure for preventing rail gnawing, comprising:
a first rail,
a second rail parallel to the first rail,
a driving trolley disposed on the first rail,
a driven trolley disposed on the second rail,
two beams connected between the driving trolley and the driven trolley, each of which has a sliding groove, and
an electric hoist disposed on the two beams, wherein:
the driving trolley is hung on the first rail through a first bearing wheel,
the driven trolley is hung on the second rail through a second bearing wheel,
the driving trolley is fixedly connected to hole grooves of the two beams through a first bolt group,
the driven trolley is movably connected to the sliding groove of each of the two beams through a double-headed bolt group,
the electric hoist is fixed on a sliding frame through a second bolt group,
the sliding frame is connected with a T-shaped bolt group and is slidingly connected to the sliding groove of each of the two beams through the T-shaped bolt group,
the driving trolley is connected with a driving motor, and
the driving trolley is configured to drive the driven trolley to synchronously move along length directions of the first rail and the second rail through the two beams so that the electric hoist is driven to synchronously move.

2. The walking device with the self-adaptive track gauge and wheel pressure for preventing rail gnawing according to claim 1, wherein:
the driving trolley comprises a first left frame, a first right frame, a third bolt group, a fourth bolt group, the driving motor, a transmission gear box, a first bearing wheel, a first rail side balance wheel group, and a first rail bottom balance wheel group,
the first left frame and the first right frame are connected to each other through the third bolt group for limiting a frame distance between the first left frame and the first right frame and the fourth bolt group for connecting the first left frame and the first right frame,
the driving motor and the transmission gear box are connected to the first left frame and the first right frame through a sixth bolt group,
the first bearing wheel is respectively supported on the first left frame and the first right frame through bearings and shafts,
the first rail side balance wheel group is connected to the first left frame and the first right frame through a first support frame and a fifth bolt group, and
the first rail bottom balance wheel group is connected to the first left frame and the first right frame through a balance wheel base and a sixth bolt group.

3. The walking device with the self-adaptive track gauge and wheel pressure for preventing rail gnawing according to claim 2, wherein:
the driven trolley comprises a second left frame, a second right frame, a seventh bolt group, an eighth bolt group, a second bearing wheel, a second rail side balance wheel group, and a second rail bottom balance wheel group,
the second left frame and the second right frame are connected to each other through the seventh bolt group for limiting a frame distance between the second left frame and the second right frame and the eighth bolt group for connecting the second left frame and the second right frame,
the second bearing wheel is respectively supported on the second left frame and the second right frame through bearings and shafts,
the second rail side balance wheel group is connected to the second left frame and the second right frame through a second support frame and a ninth bolt group,
the second rail bottom balance wheel group is connected to the second left frame and the second right frame through the balance wheel base and a tenth bolt group.

4. The walking device with the self-adaptive track gauge and wheel pressure for preventing rail gnawing according to claim 3, wherein:
the first rail side balance wheel group comprises four first rail side balance wheels,
the second rail side balance wheel group comprises four second rail side balance wheels,
the first rail bottom balance wheel group comprises two first rail bottom balance wheels, and
the second rail bottom balance wheel group comprises two second rail bottom balance wheels.

5. The walking device with the self-adaptive track gauge and wheel pressure for preventing rail gnawing according to claim 4, wherein:
a structure of each of the four first rail side balance wheels is the same as a structure of each of the four second rail side balance wheels,
each of the four first rail side balance wheels comprises the first support frame, a first balance wheel base, a first balance wheel limit adjusting bolt, a first balance wheel support, a first balance wheel, a first guide rod bolt group, and a first compression spring,
the first balance wheel base is connected to the first support frame through the first guide rod bolt group,
the first guide rod bolt group sequentially passes through the first balance wheel base, the first support frame, the first compression spring, and the first balance wheel support to enable the first compression spring, the first balance wheel support, and the first guide rod bolt group to be connected together,
the first compression spring presses the first balance wheel against a side of the first rail through the first balance wheel support, and
the first balance wheel limit adjusting bolt defines a retracted location at which the first balance wheel support is configured to be located along a first guide rod through a first nut which is fixedly connected at a middle location of the first balance wheel base, so as to define a maximum offset distance of the driving trolley and the driven trolley along a direction vertical to the side of the first rail and a side of the second rail.

6. The walking device with the self-adaptive track gauge and wheel pressure for preventing rail gnawing according to claim 5, wherein:
a structure of each of the two first rail bottom balance wheels is the same as a structure of each of the two second rail bottom balance wheels,
each of the two second rail bottom balance wheels comprises the balance wheel base, a second balance wheel limit adjusting bolt, a second balance wheel support, a second balance wheel, a second compression spring, a second guide rod bolt group, and the tenth bolt group,
the balance wheel base is connected to the second left frame and the second right frame through the tenth bolt group,
the second guide rod bolt group is connected to the balance wheel base through a nut fixed on the balance wheel base,
the second guide rod bolt group sequentially passes through the balance wheel base, the second left frame, the second right frame, the second compression spring, and the second balance wheel support to enable the second compression spring, the second balance wheel support, and the second guide rod bolt group to be connected together,
the second compression spring presses the second balance wheel against a bottom of the second rail through the second balance wheel support, and
the second balance wheel limit adjusting bolt defines a retracted location at which the second balance wheel support is configured to be located along a second guide rod through a second nut which is fixedly connected at a middle location of the balance wheel base, so as to define a maximum jumping distance of the driven trolley along a direction vertical to the bottom of the second rail.

7. The walking device with the self-adaptive track gauge and wheel pressure for preventing rail gnawing according to claim 6, wherein:
the first bearing wheel comprises a first left bearing wheel and a first right bearing wheel,
the second bearing wheel comprises a second left bearing wheel and a second right bearing wheel,
the first left bearing wheel, the second left bearing wheel, and the second right bearing wheel are driven wheels,
the first right bearing wheel is connected to the driving motor,
the first right bearing wheel is a driving wheel, and
the driving motor is configured to transmit power to the driving wheel so as to drive the driven wheels to move along the first rail and the second rail.

8. The walking device with the self-adaptive track gauge and wheel pressure for preventing rail gnawing according to claim 7, wherein:
a track gauge between the first rail and the second rail is represented by Lᵣₐᵢₗ,
an axle distance between the first left bearing wheel and the first right bearing wheel is represented by Lₐₓₗₑ,
an axle distance between two of the four first rail side balance wheels that are located on a same side of the first rail is represented by L_{wheel},
a distance between a driving force F_{driving} of the driving wheel and a friction force F₅ on a first of the driven wheels is represented by L_{driving},
a distance between friction forces F₆, F₇ on a second and third of the driven wheels is represented by L_{driven},
an acting force of the first rail acting on the driving wheel is the driving force F_{driving} whose direction is the same as a moving direction of the walking device,
rolling frictions applied by the second rail to the driven wheels are resistance forces represented by F₁, F₂, F₃, F₄, F₅, F₆, and F₇,
the driving force F_{driving} applied on the driving wheel and the rolling frictions F₁, F₂, F₃, F₄, F₅, F₆, F₇ applied on the driven wheels are configured to generate a deflection torque around a center O of the walking device so that a respective two of the four first rail side balance wheels that are arranged on two sides of the first rail and a respective two of the four second rail side balance wheels that are arranged on two sides of the second rail are respectively pressed onto the two sides of the first rail and the two sides of the second rail to generate four rail side pressures F_{N1}, F_{N2}, F_{N3}, and F_{N4},
the four rail side pressures F_{N1}, F_{N2}, F_{N3}, and F_{N4} are configured to generate a torque that balances the deflection torque,
an equilibrium equation between force and moment is shown as follow:
F_{driving}=F₂+F₃+F₄+F₅+F₆+F₇ (1),
F_{N1}+F_{N3}=F_{N2}+F_{N4} (2),
(F_{driving}+F₅)×L_{driving}+(F₆−F₇)×L_{driven}+(F₃+F₄−F₁−F₂)×Lᵣₐᵢₗ=L_{wheel}×(F_{N1}+F_{N2}+F_{N3}+F_{N4}) (3),
a rail width of the first rail and the second rail is negligible relative to the track gauge Lᵣₐᵢₗ, so that L_{driving}=L_{driven}=Lᵣₐᵢₗ,
the formulas (1) and (2) are substituted into the formula (3) to obtain the formula (4):
(F₃+F₄+F₅+F₆)×Lᵣₐᵢₗ=(F_{N1}+F_{N3})×L_{wheel} (4),
rolling friction coefficients of the driving wheel and the driven wheels are considered as fᵣₒₗₗ, so that F_{N1}=F_{N2}=F_{N3}=F_{N4}=F_{N}, F₃+F₄=(F_{N3}+F_{N4})×fᵣₒₗₗ=2×F_{N}'fᵣₒₗₗ, and F₅+F₆=F_{weight}×fᵣₒₗₗ, wherein the F_{weight} is a total weight borne by the second bearing wheel of the driven trolley,
the above formulas are substituted into formula (4) to obtain the formulas (5) and (6):
$$\begin{matrix}FN = \frac{Fweight \times froll \times Lrail}{2 \times Lwheel - 2 \times froll \times Lrail} , & ( 5 ) \\ Lwheel = [ \frac{Fweight}{2 \times FN} + 1 ] \times froll \times Lrail , & ( 6 )\end{matrix}$$
the formula (5) illustrates a relationship among the F_{N}, the fᵣₒₗₗ, the L_{wheel}, the Lᵣₐᵢₗ, and the F_{weight},
under a condition that other parameters are fixed, the fᵣₒₗₗ is positively correlated with the F_{N}; the L_{wheel} is negatively correlated with the F_{N}; the Lᵣₐᵢₗ is positively correlated with the F_{N}; and the F_{weight} is positively correlated with the F_{N},
the formula (6) illustrates a method for setting the axle distance relative to the track gauge, and
the method comprises: (1) determining a limit value F_{side limit} of the rail side pressure F_{N} according to an ultimate stress of a rail material, (2) substituting the F_{side} limit into the formula (6) to obtain a lowest limit value of the L_{wheel}, and (3) selecting a value of the L_{wheel} according to the lowest limit value of the L_{wheel}.

9. The walking device with the self-adaptive track gauge and wheel pressure for preventing rail gnawing according to claim 8, wherein:
the hole grooves of each of the two beams is divided into a first hole groove and a second hole groove,
the driving trolley is fixedly connected with the first hole groove and the second hole groove through the first bolt group,
a length of an unthreaded part of a double-headed bolt of the double-headed bolt group is greater than a sum of a thicknesses of a corresponding one of the second left frame or the second right frame and each of the two beams at a junction of the corresponding one of the second left frame and the second right frame and each of the two beams,
when a distance between the first rail and the second rail is changed, the driven trolley and the double-headed bolt group slide along the sliding groove so as to adapt different track gauges,
a gravity center of the driving trolley is marked as O,
F_{G} is a gravity of the driving trolley,
F_{bearing 1} and F_{bearing 2} are positive pressures which are respectively applied to the first left bearing wheel and the first right bearing wheel by the first rail,
F_{N5} and F_{N6} are positive pressures which are respectively applied by the first rail to the two first rail bottom balance wheels, which are separated from each other in a front-rear direction,
F_{beam 1} and F_{beam 2} are downward pulling forces which are applied by the two beams to the first left frame and the first right frame of the driving trolley,
an equilibrium equation for force and moment is shown as follow,
F_{bearing 1}+F_{bearing 2}=F_{G}+F_{N5}+F_{N6}+F_{beam 1}+F_{beam 2} (7),
(F_{bearing 1}−F_{bearing 2})×Lₐₓₗₑ=(F_{N5}−F_{N6})×L_{wheel}+(F_{beam 1}−F_{beam 2})×L_{beam} (8),
L_{beam} is a distance between the two beams,
when F_{beam 1}=F_{beam 2}, F_{bearing 1}=F_{bearing 2} and the first left bearing wheel and the first right bearing wheel are stressed evenly,
the positive pressures F_{N5} and F_{N6} which are applied by the first rail to the two first rail bottom balance wheels are ignored,
when a stress on the two beams is unbalanced and the F_{beam 1} is larger than the F_{beam 2}, the driving trolley is subjected to a counterclockwise turning moment around the gravity center O,
let F_{beam 2}=0 and F_{N5}=0, then:
(F_{bearing 1}−F_{bearing 2})×Lₐₓₗₑ=F_{beam 1}×L_{beam}−F_{N6}×L_{wheel} (9),
from the above formula, when
$${F}_{beam 1} \times {L}_{beam} - {F}_{N 6} \times {L}_{wheel} = 0 , {F}_{N 6} = \frac{{F}_{beam 1} \times {L}_{beam}}{{L}_{wheel}} , {F}_{bearing 1} - {F}_{bearing 2} = 0$$
and the first left bearing wheel and the first right bearing wheel are still stressed in balance, and
the formula (9) shows that when the stress on the two beams is unbalanced, the two first rail bottom balance wheels are configured to reduce an unbalanced degree of the stress on the first left bearing wheel and the first right bearing wheel.

10. The walking device with the self-adaptive track gauge and wheel pressure for preventing rail gnawing according to claim 9, wherein:
when a direction of a trolley body and a direction of the rail deviate from each other and the four first rail side balance wheels and the four second rail side balance wheels reach a maximum retraction distance b due to a limitation of a limit adjusting bolt:
a deflection angle is a maximum deflection angle α,
a diameter of each of the four first rail side balance wheels is set as d₁,
diameters of a first bearing wheel and a second bearing wheel are set as d₂,
a width of the rail is set as w,
a wall thickness of the rail is set as s, then
$$2 \times b + {d}_{1} + s - \frac{{d}_{1} + s}{cos α} = {L}_{wheel} \times tan α , \qquad ( 10 )$$
the larger the maximum retraction distance b, the larger the maximum deflection angle α; and when b is determined, the maximum deflection angle α is determined,
a condition that the rail gnawing does not occur is that projection straight lines EF, GH of a rail edge of the rail projected on a rail plane do not intersect with sides AB, DC of a circumscribed rectangle ABCD projected by the first left bearing wheel and the first right bearing wheel on the rail plane, then:
$$BC \geq ( {L}_{axle} + {d}_{2} ) \times tan α + \frac{w}{cos α} , \qquad ( 11 )$$
BC=w+c is set, wherein c is a minimum gap value which should be reserved between an edge of each of the first left bearing wheel and the first right bearing wheel and the rail edge of the rail after the driving trolley is installed on the rails, then:
$$c \geq ( {L}_{axle} + {d}_{2} ) \times tan α - w + \frac{w}{cos α} , \qquad ( 12 )$$
the minimum gap value c between the edge of each of the first left bearing wheel and the first right bearing wheel and the rail edge of the rail is adjusted through a frame spacing limiting bolt group and a frame connecting bolt group, and the maximum retraction distance b is adjusted through a balance wheel limit adjusting bolt,
according to the formulas (10) and (12), when the minimum gap value c is given, the maximum deflection angle α of the rail and the maximum retraction distance b of rail side balance wheels which are set to prevent rail gnawing is configured to be calculated,
when the maximum retraction distance b of rail side balance wheels is given, the maximum deflection angle α of the rail and the minimum gap value c at which no rail gnawing occurs is configured to be calculated,
the frame distance between the first left frame and the first right frame and the frame distance between the second left frame and the second right frame are configured to be adjusted to adjust the minimum gap value c,
a method of adjusting the frame distance between the first left frame and the first right frame is the same as a method of adjusting the frame distance between the second left frame and the second right frame,
the method of adjusting the frame distance between the first left frame and the first right frame comprises: tightening the fourth bolt group to decrease the frame distance between the first left frame and the first right frame, or to loosening the fourth bolt group to increase the frame distance between the first left frame and the first right frame,
when the frame distance between the first left frame and the first right frame reaches a set value, the third bolt group is tightened to maintain the frame distance at the set value,
in order to adjust the four first rail side balance wheels and the two beams to adapt to the frame distance between the frames, through grooves are arranged on the first left frame, the first right frame, and the two beams, and
the frame distance between the first left frame and the first right frame is configured to be adjusted to enable the driving trolley and the driven trolley to be suitable for rails of different types or widths.
